(19) United States
(12) Patent Application Publication
(10) Pub. No.: US 2017/0323346 A1
(43) Pub. Date: Nov. 9, 2017

(54) Segmented Advertising Database System

(71) Applicant: ADP, LLC, Roseland, NJ (US)

(72) Inventors: Scott Sheppard, Roseland, NJ (US); Sandra Angevine, Pelham, NY (US)

(21) Appl. No.: 15/587,594

(22) Filed: May 5, 2017

Related U.S. Application Data
(60) Provisional application No. 62/332,547, filed on May 6, 2016.

(51) Int. Cl. G06Q 30/02

(52) U.S. Cl. CPC G06Q 30/0269

(57) ABSTRACT

A method and apparatus for managing a personalization database. The computer system selects a number of segments of profile information about a user from a plurality of segments of the profile information about the user located in a human resources database. A record for the user in the personalization database is identified by the computer system, wherein an anonymized identifier for the user is used to locate the record. The number of segments selected is placed, by the computer system, into the record for the user in the personalization database, wherein a profile manager for the personalization database handles requests for information about users.

### RELATED PROVISIONAL APPLICATION

This application claims the benefit of U.S. Provisional Patent Application Ser. No. 62/332,547, filed May 6, 2016, and entitled “Segmented Advertising Database System.”

### CROSS-REFERENCE TO RELATED APPLICATION

This application is related to the following patent application, entitled “Segmented User Profiles”, attorney docket number E52016004-1, U.S. Ser. No. ______, filed even date herewith, which is incorporated herein by reference in its entirety.

### BACKGROUND INFORMATION

### 1. Field

The present disclosure relates generally to an improved computer system and, in particular, to a method and apparatus for generating advertisements for web pages. Still more particularly, the present disclosure relates to a method and apparatus for creating web pages with advertisements targeted to users using segmented user profiles that are anonymized.

### 2. Background

The Internet is a global system of interconnected computer networks that link computers and other data processing systems worldwide. The connections are made through an array of electronic, wireless, and optical networking technologies. The Internet provides an extensive range of information and services.

The Internet is used to perform a variety of activities. For example, users employ the Internet to read articles, watch news reports, listen to music, send messages, perform research, play online games, perform banking transactions, purchase products and services, pay bills, talk to other people using voice communications, and perform other activities over the Internet.

For example, users may access information in documents or in other forms on the World Wide Web. The World Wide Web, which is also referred to just as the Web, is an open source information space accessed through the Internet. Users typically access web pages. Web pages are primarily text documents that are formatted in a markup language, such as hypertext markup language (HTML). In addition to formatted text, the web pages may also include images, video, software components, or other elements that are presented through a web browser. The presentation may be a display of information, an audio presentation, a multimedia presentation, or some combination thereof.

An organization, such as a company, a partnership, a charity, an educational group, a social group, a team, a city, a government agency, or some other suitable organization, may establish a presence on the Web using a website. Some organizations may perform various transactions using a website. For example, a business may offer goods or services to users through a website.

With the vast number of businesses that offer goods or services over the Web, identifying which businesses have good customer service, are reputable, or have other characteristics that are desirable in making purchases may be harder to identify than desired.

These different businesses often advertise over various types of media. For example, many businesses use online advertising. Online advertising includes e-mail marketing, search engine marketing, social media marketing, mobile advertising, and other various types of display advertising on web browsers. Advertisements may be integrated into content in web pages requested by users. These advertisements may be in the form of banners, floating ads, newsfeed ads, and other types of advertisements that users may view while online on the Internet.

A website may target advertising to users who visit the website. For example, cookies, pixel tags, text files, device identifiers, or other techniques for uniquely identifying visitors to websites are used to identify and collect information about the users.

These identifiers are used to identify a user that visits a website and to associate activities of the user at the website with the user. The activities may be used to place the user into categories or groups based on the activities tracked during visits to websites.

For example, a user may look at sport cars on websites. Viewing sports cars on the websites may be used to place the user into a category, such as sports cars. Also, the activities of the user on the websites may be used to place the user into other categories, such as gender and age group, which may be identified. Further, geographic location may be identified from the Internet Protocol (IP) address of the device and global positioning system (GPS) information from the device in addition to activities of the user.

This information about the user is placed into advertising databases in association with a unique identifier for the user without actually identifying the user. The information is collected and maintained by a website publisher, an advertiser of an item, a third party advertising company, or some combination thereof.

When the user visits a website, the unique identifier is used to obtain the information collected about the user. This information is used to select one or more advertisements that are placed into a web page that is sent to a browser or content that is sent to an application on the device when the user visits the website.

In many cases, the association of the information is based on the activities of the users at different websites. The activities, however, may not always provide for an accurate identification of the information about the users. For example, a user searching a website for men's shirts commonly worn by men in the age group of 25-34 years may not be a male that is in the age group of 25-34 years. Instead, the user may be a woman in the age group of 50-55 years who is searching for a gift for her son-in-law. As a result, targeting advertisements based on the age group of 25-34 years may not generate the desired results.

Further, the information collected from the activities of the users may not be useful to all advertisers for items. For example, age groups and clothing preferences of the users are not very useful to a car company that advertises a sports car.

Therefore, it would be desirable to have a method and apparatus that take into account at least some of the issues discussed above, as well as other possible issues. For example, it would be desirable to have a method and apparatus that overcome a technical problem with obtaining useable information about users for use in selecting advisements for the users visiting websites.

### SUMMARY

An embodiment of the present disclosure provides a method for managing a personalization database. The computer system selects a number of segments of user profile information about a user from a plurality of segments of the user profile information about the user located in a profile database. A record for the user in the personalization database is identified by the computer system, wherein an anonymized identifier for the user is used to locate the record. The number of segments selected is placed, by the computer system, into the record for the user in the personalization database, wherein a profile manager for the personalization database handles requests for information about user, enabling personalization of content for the users.

Another embodiment of the present disclosure provides an advertising system that comprises a personalization database and a profile manager. The profile manager selects a number of segments of human resources profile information about a user from a plurality of segments of user profile information about the user located in a profile database. Further, the profile manager identifies a record for the user in the personalization database, wherein an anonymized identifier for the user is used to locate the record. Yet further, the profile manager places the number of segments selected into the record for the user in the personalization database, wherein the profile manager for the personalization database handles requests for information about users.

Yet another embodiment of the present disclosure provides a computer program product for managing human resources profile information that comprises a computer-readable storage media. The computer program product also comprises first program code, second program code, and third program code, which are all stored on a computer on the computer-readable storage media. The first program code selects a number of segments of user profile information about a user from a plurality of segments of the user profile information about the user located in a human resources database. The second program code identifies a record for the user in a personalization database, wherein an anonymized identifier for the user is used to locate the record. The third program code places the number of segments selected into the record for the user in the personalization database, wherein a profile manager for the personalization database handles requests for information about users.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof, will best be understood by reference to the following detailed description of an illustrative embodiment of the present disclosure when read in conjunction with the accompanying drawings, wherein:

FIG. 1 is an illustration of an information environment in accordance with an illustrative embodiment;

FIG. 2 is a block diagram of an advertising system in accordance with an illustrative embodiment;

FIG. 3 is an illustration of a reply in accordance with an illustrative embodiment;

FIG. 4 is an illustration of a registration database in accordance with an illustrative embodiment;

FIG. 5 is an illustration of a dataflow in creating a personalization database in accordance with an illustrative embodiment;

FIG. 6 is an illustration of dataflow in updating an advertising database in accordance with an illustrative embodiment;

FIG. 7 is an illustration of dataflow in displaying advertisements on client devices;

FIG. 8 is an illustration of a flowchart of a process for managing profile information in accordance with an illustrative embodiment;

FIG. 9 is an illustration of a flowchart of a process for managing a personalization database in accordance with an illustrative embodiment;

FIG. 10 is an illustration of a flowchart of a process for identifying human resources profile information using a policy in accordance with an illustrative embodiment;

FIG. 11 is an illustration of a flowchart of a process for anonymizing human resources profile information in accordance with an illustrative embodiment;

FIG. 12 is an illustration of a flowchart of a process for processing permissions in accordance with an illustrative embodiment;

FIG. 13 is an illustration of a flowchart of a process for creating an advertising database with segmented profiles in accordance with an illustrative embodiment;

FIG. 14 is an illustration of a flowchart of a process for updating and advertising a database in accordance with an illustrative embodiment; and

FIG. 15 is an illustration of a block diagram of a data processing system in accordance with an illustrative embodiment.

### DETAILED DESCRIPTION

The illustrative embodiments recognize and take into account one or more different considerations. For example, in addition to accuracy of information, the illustrative embodiments recognize and take into account that the amount of information received for selecting advertisements may be more than desired. The illustrative embodiments also recognize and take into account that the amount of detail of information also may vary depending on what item is being advertised.

An item may take different forms. For example, an item is selected from one of a product, a service, an entity, a person, an organization, a company, a partnership, a charity, an educational group, a social group, a team, a city, a government agency, a theme park, a restaurant, or some other suitable item that may be advertised.

Thus, the illustrative embodiments provide a method and apparatus for managing human resources profile information. In one illustrative example, a process receives a request for a group of segments of the human resources profile information for a user from a requestor. A profile for the user is identified in a profile database. The profile is comprised of the segments of the human resources profile information about the user. A portion of the human resources profile information corresponding to the group of segments is sent in a reply to the requestor. The portion of the human resources profile information is used to generate an advertisement that is placed into a web page or content for the user, enabling receiving the information requested and reducing the amount of processing resources by not requesting information that is not needed by the requestor.

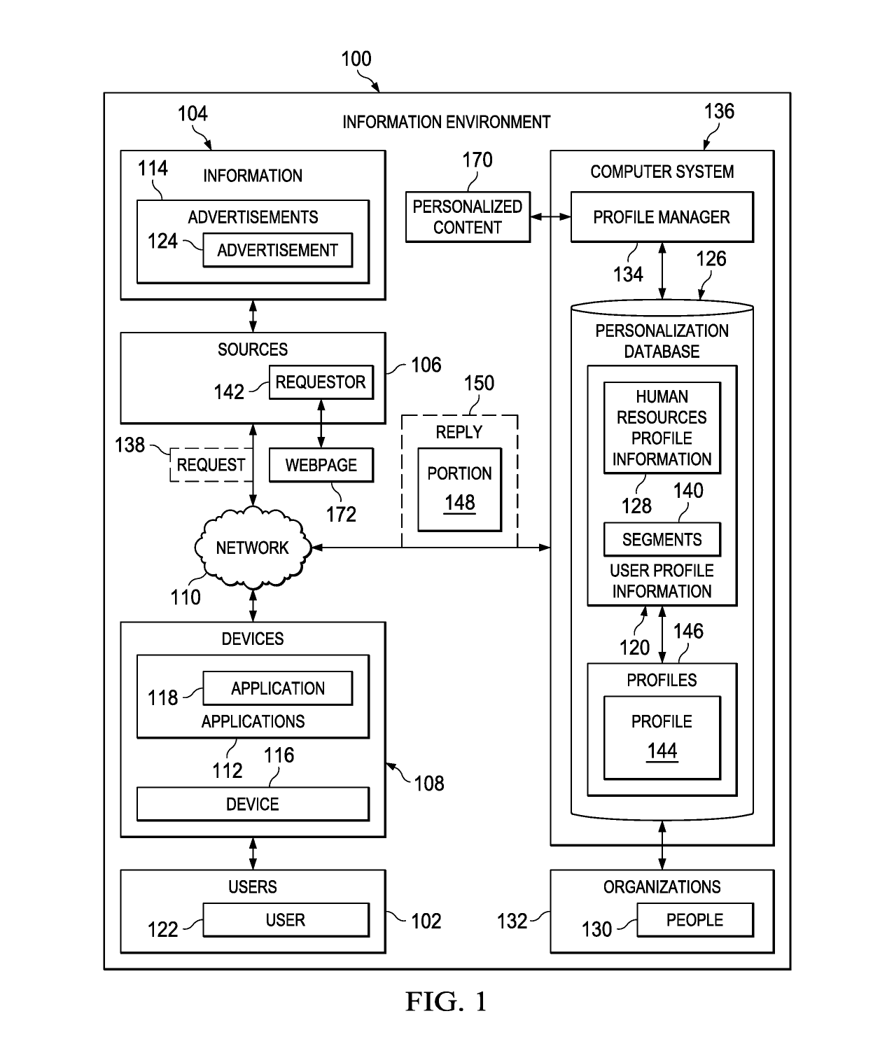

With reference now to the figures and, in particular, with reference to FIG. 1, an illustration of an information environment is depicted in accordance with an illustrative embodiment. In this depicted example, information environment 100 includes users 102 who may search for and request information 104 from sources 106 while operating devices 108. In this illustrative example, users 102 are people.

Sources 106 comprise physical hardware and may include at least one of server computers, web servers, proxy servers, file transfer protocol servers, work stations, personal computers, laptop computers, tablets, mobile phones, or any other type of data processing system that may store information 104.

Devices 108 are physical hardware in the form of data processing systems. As depicted, devices 108 may be selected from at least one of a computer, a laptop computer, a tablet, a mobile phone, or some other suitable type of device that may process information 104.

As depicted, devices 108 and sources 106 communicate with each other over network 110. Network 110 is a communications medium and may include at least one of a local area network, a wide area network, an Internet, an intranet, or other suitable types of networks.

As used herein, the phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In this illustrative example, sources 106 send information 104 to applications 112 running on devices 108. Applications 112 may include at least one of a browser, a mobile application, or some other suitable type of application that is configured to receive and display or, otherwise, present information 104.

In this example, information 104 also includes advertisements 114 that may be sent to applications 112. User profile information 120 is used to manage advertisements 114.

Managing advertisements 114 includes generating and storing advertisements 114. Generating advertisements 114 includes selecting existing ones of advertisements 114. Generating advertisements 114 also includes creating advertisements 114 as needed if desired advertisements are not already present in advertisements 114. For example, advertisement 124 in advertisements 114 may be dynamically generated to target user 122 in users 102. In particular, advertisement 124 is received by application 118 in applications 112 that runs on device 116 for user 122.

User profile information 120 is information about users 102 and is stored in personalization database 126. Personalization database 126 is an organized collection of user profile information 120. In other words, personalization database 126 comprises user profile information 120 and the way user profile information 120 is organized. In this example, user profile information 120 includes human resources profile information 128.

Human resources profile information 128 includes information about people 130 in a group of organizations 132. As used herein, “a group of”, when used with reference to items, means one or more items. For example, “a group of organizations 132” is one or more of organizations 132. When the group of organizations 132 is a company with people 130 in the form of employees, human resources profile information 128 is information about the employees. For example, the information may be information about payroll, benefits, retirement, or other information about the employees.

Human resources profile information 128 is used to perform operations with respect to people 130. As depicted, human resources profile information 128 is at least one of more detailed or more accurate, as compared to current sources of information for advertisements 114 using information about users 102 that is collected or mined for monitoring activities of users 102.

The information is often verified or input by people 130. For example, human resources profile information 128 may be identified for inclusion in user profile information 120 in personalization database 126 from application 118 on device 116 used by user 122 in which application 118 is selected from one of a payroll application and a benefits application. In other words, human resources profile information 128 may be received from user 122 from application 118 running on device 116.

For example, user 122 may enter information, such as name, address, age, and other suitable information about user 122 using application 118. In another illustrative example, user 122 may enter information about other ones of users 102 using application 118.

As a result, user 122 may enter human resources profile information 128 for user 122 or others in users 102 or people 130 as part of a human resources operation. Human resources profile information 128 may be selected from at least one of payroll, insurance, employee benefits, reviews, or other information about people 130 in the group of organizations 132.

As depicted, profile manager 134 manages user profile information 120. The management of user profile information 120 includes as least one of reading, writing, deleting, or other operations with respect to user profile information 120.

Profile manager 134 may be implemented in software, hardware, firmware, or a combination thereof. When software is used, the operations performed by profile manager 134 may be implemented in program code configured to run on hardware, such as a processor unit. When firmware is used, the operations performed by profile manager 134 may be implemented in program code and data and stored in persistent memory to run on a processor unit. When hardware is employed, the hardware may include circuits that operate to perform the operations in profile manager 134.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

In this illustrative example, profile manager 134 is located in computer system 136. Computer system 136 is a physical hardware system and includes one or more data processing systems. When more than one data processing system is present, those data processing systems are in communication with each other using a communications medium. The communications medium may be a network. The data processing systems may be selected from at least one of a computer, a server computer, a tablet, or some other suitable data processing system.

Profile manager 134 is configured to receive request 138 for a group of segments 140 of user profile information 120 about user 122 from requestor 142. The group of segments 140 may be some or all of segments 140 of user profile information 120 about user 122.

As depicted, request 138 is sent through network 110. Profile manager 134 identifies profile 144 from profiles 146 for user 122 in personalization database 126. Profile 144 is comprised of segments 140 of user profile information 120 about user 122. Profile manager 134 identifies and sends portion 148 of user profile information 120 in profile 144 corresponding to the group of segments 140 in reply 150 to requestor 142 in sources 106. In this example, reply 150 is sent to requestor 142 through network 110.

Segments 140 are categories or bins in which user profile information 120 may be sorted by or in which user profile information 120 may be placed. In this illustrative example, a segment in segments 140 may be selected from one of a work location, a residence location, an age group, a gender, a job, an education, a health history, a title, an industry, a hobby, a type of insurance, a salary, or some other suitable type of information.

In the illustrative examples, requestor 142 may be part of sources 106 or may be a separate entity that communicates with sources 106 to manage advertisements 114. For example, requestor 142 may be a Web server, an advertisement distribution server, or some other type of hardware system that manages or aids in the management of advertisements 114. Requestor 142 may be operated by one of a website operator, an advertiser, a third party advertiser, or some other type of organization.

In one illustrative example, one or more technical solutions are present that overcome a technical problem with obtaining useable information about users for use in generating advisements for the users visiting websites. As a result, one or more technical solutions may provide a technical effect providing a desired amount of information about users 102 for sending advertisements 114 to users 102 in web pages or other content.

As a result, computer system 136 operates as a special purpose computer system in which profile manager 134 in computer system 136 enables sending user profile information 120 for use in targeting advertisements 114 to users 102, but in a fashion that is anonymized from the form in user profile information 120 and, in particular, when user profile information 120 is human resources profile information 128.

As depicted, anonymization of user profile information 120 involves removing or changing user profile information 120 to remove personally identifiable information about users 102. For example, user profile information 120 is sent in a manner such that users 102 cannot be identified from user profile information 120 that is sent for use in generating advertisements 114. Targeting advertisements 114 to users 102 means that advertisements 114 are generated for users 102 in a manner that is intended to obtain attention or persuade users 102 to purchase goods or services.

In this manner, current repositories of human resources profile information 128 may be leveraged and used in targeting advertisements 114 when using profile manager 134. In particular, profile manager 134 transforms computer system 136 into a special purpose computer system as compared to currently available general computer systems that do not have profile manager 134.

Further, requestor 142 may generate information 104 in addition to or in place of advertisement 124 to personalize content to form personalized content 170 for user 122. In this illustrative example, information 104 may be generated by requestor 142 by selecting information 104, creating information 104, or some combination thereof. Requestor 142 may generate personalized content 170 in which personalized content 170 includes at least one of advertisement 124, an image, a video, a news article, a forum thread, a link to a website, or other suitable types of personalized content 170 that are based on user profile information 120 about user 122. One or more of all of the different types of personalized content 170 may be used to generate personalized content 170 for user 122.

For example, requestor 142 may generate web page 172 using personalized content 170. Web page 172 may include other content as well as personalized content 170 in this illustrative example.

Requestor 142 sends web page 172 to device 116 operated by user 122. Web page 172 is displayed by application 118, which is the form of a web browser or other application that is configured to display web page 172.

In other illustrative examples, personalized content 170 may be sent to application 118 for personalizing the display of information by application 118. For example, application 118 may be a news application that displays newsfeeds. Personalized content 170 may include selected news articles that are based on a group of segments 140 of user profile information 120 about user 122. In this manner, a personalized experience may be created for user 122 when operating device 116 with application 118.

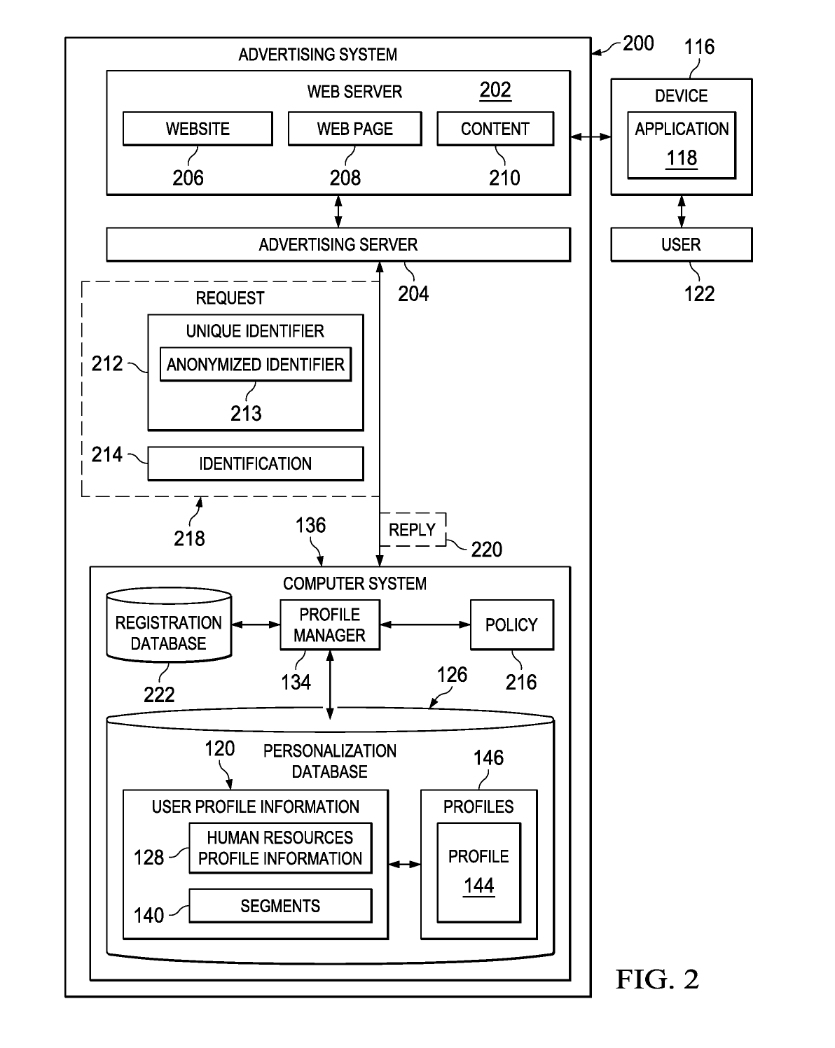

Turning next to FIG. 2, a block diagram of an advertising system is depicted in accordance with an illustrative embodiment. In the illustrative examples, the same reference numeral may be used in more than one figure. This reuse of a reference numeral in different figures represents the same element in the different figures. Advertising system 200 may be implemented in information environment 100 in FIG. 1 using one or more components in information environment 100.

In this illustrative example, advertising system 200 includes web server 202, advertising server 204, and profile manager 134. As depicted, web server 202 is an example of a source in sources 106 in FIG. 1. In this illustrative example, advertising server 204 is an example of requestor 142 in FIG. 1 and may be a source in sources 106.

During operation of advertising system 200, web server 202 sends at least one of web page 208 or content 210 in information 104 in FIG. 1 to user 122 when user 122 visits website 206 hosted by web server 202. Information 104 is sent to application 118 running on device 116 that is operated or owned by user 122.

As depicted, web page 208 is stored by web server 202 for distribution. Web page 208 also may be dynamically generated when requested by user 122 visiting website 206. Web page 208 is sent to application 118 when application 118 is a browser or a browser-enabled application.

As depicted, content 210 may be used to generate web page 208. Further, content 210 may be sent to application 118 when a link or links are selected in web page 208. Those links may be for content 210 located on web server 224 or from other web servers or sources 106 in FIG. 1.

In the illustrative example, content 210 also is stored by web server 202. Content 210 may be sent directly to application 118 running on device 116 when application 118 takes other forms other than a browser or a web-enabled application that processes web page 208.

As depicted, content 210 takes various forms. For example, content 210 may be selected from at least one of a video, images, audio files, documents, spreadsheets, or other types of content.

Further, web server 202 sends advertisements 114 in FIG. 1 to user 122. Advertisements 114 are placed into web page 208 or included in content 210 and sent to application 118.

In this depicted example, web server 202 identifies user 122 when user 122 visits website 206. This identification is made by web server 202 using unique identifier 212 stored on device 116.

Unique identifier 212 may take a number of different forms. For example, unique identifier 212 may be a cookie, a pixel tag, a text file, a device identifier, an Internet Protocol address, a device fingerprint, a browser fingerprint, or some other suitable mechanism that is currently used to identify users visiting websites. A device identifier may be, for example, a unique identifier for a processor unit, a media access control (MAC) address, or some other identifier based on hardware. The device identifier may be assigned to and stored on device 116. In these illustrative examples, unique identifier 212 is anonymized identifier 213 such that the name of user 122 cannot be identified.

This identification is often anonymous without identifying the name of the user. For example, the identification may only be unique identifier 212. In other examples, the identification may include the name of user 122 if user 122 logs into an account at website 206. In this case, unique identifier 212 may be at least one of the name of the user, a unique alphanumeric string, a number, or some other suitable form of identification.

As depicted, web server 202 identifies unique identifier 212 for user 122 and sends unique identifier 212 to advertising server 204. Advertising server 204 is an example of an implementation for requestor 142 in FIG. 1. Advertising server 204 identifies a group of segments 140 of human resources profile information 128 for which advertising server 204 wants to receive for use in including advertisement 124 in FIG. 1 in web page 208. Advertising server 204 uses profile manager 134 to make this identification of the group of segments 140.

As depicted, advertising server 204 sends unique identifier 212 for user 122 and identification 214 of the group of segments 140 in request 218 to profile manager 134. In this example, the group of segments 140 is one or more of segments 140 that are desired for use in generating advertisement 124 in FIG. 1.

In response to receiving request 218, profile manager 134 identifies profile 144 in profiles 146 for user 122. In this example, the identity of user 122 is identified from unique identifier 212. With the identification of user 122, profile 144 in human resources profile information 128 for user 122 may be identified.

For example, application 118 may have unique identifier 212 that is registered in human resources profile information 128. As another example, device 116 may have unique identifier 212 that is registered for user 122 with profile manager 134. In other words, web server 202 and advertising server 204 do not know the actual identity of user 122. Profile manager 134 is configured to derive the actual identity of user 122 to identify profile 144 for user 122 in human resources profile information 128.

As depicted, profile manager 134 uses registration database 222 to identify profile 144 for user 122. Profile manager 134 uses unique identifier 212 to query registration database 222 to identify profile 144 for user 122.

In this illustrative example, profile 144 includes segments 140 of human resources profile information 128 for user 122. Profile manager 134 identifies portion 148 in FIG. 1 of human resources profile information 128 in profile 144 for the group of the segments 140 of human resources profile information 128 for user 122 that corresponds to identification 214 in request 218. In this manner, the identity of user 122 may remain anonymous with respect to web server 202 and advertising server 204.

Profile manager 134 identifies portion 148 in FIG. 1 of human resources profile information 128 corresponding to the group of segments 140 using policy 216. Policy 216 is one or more rules that are used to identify portion 148. Policy 216 may also include data used in applying the rules.

As depicted, policy 216 is used by profile manager 134 to perform one or more operations on human resources profile information 128 to obtain portion 148 in FIG. 1 corresponding to the group of segments 140. For example, profile manager 134 may perform at least one of selecting, modifying, filtering, or some other selected operation on human resources profile information 128 to generate portion 148.

For example, profile manager 134 may identify a level of detail for human resources profile information 128 corresponding to the group of segments 140 using policy 216 to form portion 148 of human resources profile information 128.

In one example, human resources profile information 128 in profile 144 for user 122 includes a salary for user 122 in a segment in segments 140 that is requested by identification 214 in request 218 is a salary.

Policy 216 may include a rule that returns salary information in a salary range. Application of policy 216 results in a salary range being included in portion 148 that is returned in reply 220 rather than the actual salary.

As another example, the level of detail may also depend on permissions given by users 102 in FIG. 1. Policy 216 may also have a rule that includes checking permissions from users 102. For example, a segment for a salary may result in a salary range being returned for a first user in users 102 and no salary range or other information for a second user in users 102.

As yet another example, user 122 is employed at Company X. Based on policy 216, Company X or an industry for Company X may be returned.

The selection of the level of detail is based on a number of different factors in policy 216. The factors include at least one of privacy, a fee paid by an advertiser, or other suitable factors. For example, an increased level of detail may be present depending on the fee paid by the advertiser.

Additionally, the amount of specificity also may be based on permissions from user 122 that take into account the privacy, the fee paid to user 122, or other factors. Thus, identifying human resources profile information 128 may be identified based on permissions from user 122. For example, a permission may be set such that some or all of human resources profile information 128 for user 122 is omitted or available to advertisers requesting human resources profile information 128 for user 122. For example, the permissions may be set such that use of human resources profile information 128 for user 122 is prohibited until user 122 agrees to the use.

Profile manager 134 returns portion 148 in FIG. 1 of human resources profile information 128 corresponding to the group of segments 140 that is requested by advertising server 204 in reply 220. In response to receiving reply 220, advertising server 204 generates advertisement 124 in FIG. 1 for inclusion in web page 208.

Advertising server 204 sends advertisement 124 in FIG. 1 to web server 202. Advertisement 124 includes at least one of graphics, images, video, audio, scripts, universal resource locators (URLs), or other suitable types of content 210.

As depicted, advertising server 204 may generate advertisement 124 in FIG. 1 by selecting advertisement 124 from a database of advertisements 114 in FIG. 1 using portion 148 in FIG. 1 of human resources profile information 128 from profile 144 for user 122 returned in reply 220. Alternatively, advertising server 204 may dynamically generate advertisement 124 in selecting advertisement 124.

In other illustrative examples, advertising server 204 may send a selection of advertisements 114 in FIG. 1 to web server 202 when advertisement 124 in FIG. 1 is stored on web server 202.

In this manner, at least one of web page 208 or content 210 is personalized for user 122. This personalization provides a unique web page 208 or content 210 that is displayed to user 122 on device 116. More specifically, advertisement 124 in FIG. 1 is sent to device 116 for user 122 in a manner that is more likely to generate interest by user 122 as compared to more general advertising. Further, with the use of human resources profile information 128, a more specific generation of advertisement 124 may be made.

Further, the illustrative embodiments also recognize and take into account that another technical problem is the amount of information that is transmitted within advertising system 200 to identify advertisements 114 in FIG. 1 for inclusion in web pages or other content. Those illustrative embodiments also recognize and take into account that transmitting the information about users 102 from advertising databases may use large amounts of bandwidth in network 110 in FIG. 1 depending on the number of users 102 that are actively searching for information 104 in FIG. 1.

The illustrative examples provide one or more technical solutions in which only some of human resources profile information 128 may be transmitted from profile manager 134 to advertising server 204. In this manner, transmitting only some of human resources profile information 128 corresponding to the group of segments 140 in FIG. 1 that is requested by advertising server 204 reduces the amount of information that is transmitted. In this manner, transmitting information may be reduced in a manner that provides for at least one of a response time, bandwidth use, cost, or other factors that may meet a desired metric or level of use.

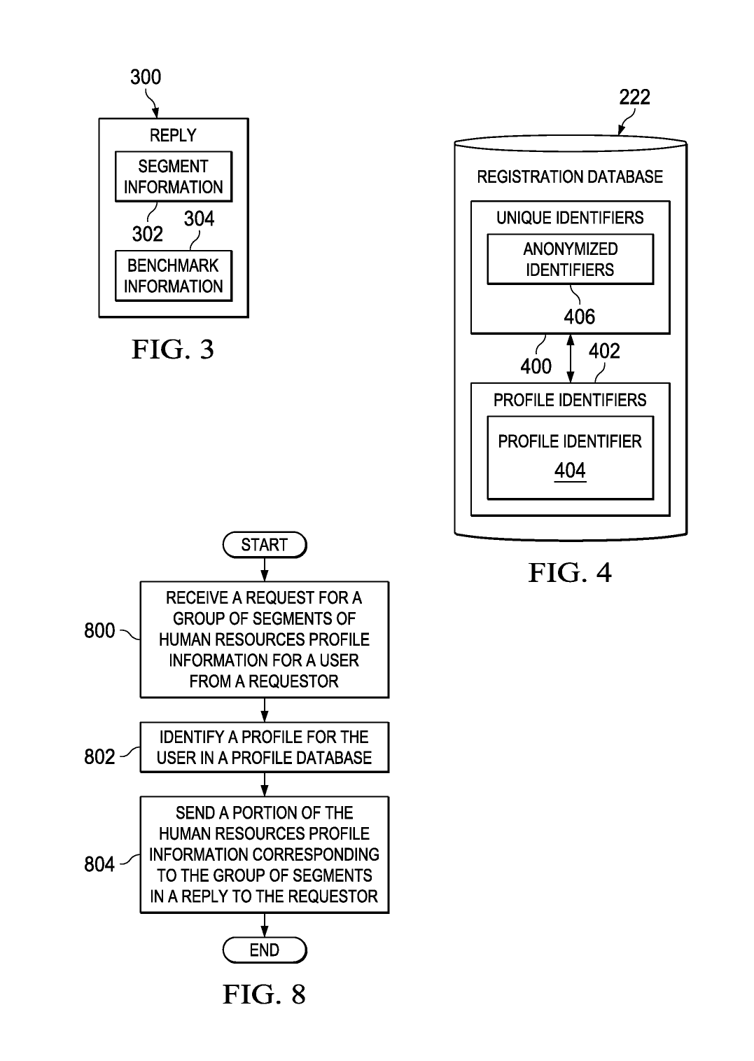

With reference now to FIG. 3, an illustration of a reply is depicted in accordance with an illustrative embodiment. In this figure, an example of information in a reply sent in response to a request for human resources profile information 128 in FIG. 1 for user 122 in FIG. 1 is shown. Reply 300 is an example of reply 150 in FIG. 1 or reply 220 in FIG. 2.

As depicted, reply 300 includes segment information 302 and benchmark information 304. Segment information 302 includes information in human resources profile information 128 in FIG. 1 that is based on a group of segments 140 in profile 144 for user 122 in FIG. 1.

Segment information 302 is comprised of at least one of human resources profile information 128 in FIG. 1 corresponding to the group of segments 140 in FIG. 1 or information derived from human resources profile information 128. Policy 216, as described above in FIG. 2, may be used by profile manager 134 in FIG. 1 to derive segment information 302 from human resources profile information 128. For example, some or all of human resources profile information 128 that corresponds to the group of segments 140 may be filtered, modified, anonymized, or otherwise changed to form segment information 302.

Benchmark information 304 is a group of benchmarks. Profile manager 134 in FIG. 1 identifies the group of benchmarks for the group of segments 140 in FIG. 1 as part of human resources profile information 128 in FIG. 1 corresponding to the group of segments 140. One or more benchmarks may be identified for each segment in the group of segments 140.

For example, when user profile information 120 is in the form of human resources profile information 128, benchmark information 304 may include benchmarks for salaries, benefits, and other types of human resources information. When user profile information 120 includes other types of profile information in addition to or in place of human resources profile information 128, benchmarks may also be present in benchmark information 304 for those other types of profile information. For example, if user profile information 120 is about user preferences with respect to cars, benchmark information 304 may include benchmarks about cars relating to the preferences of user 122.

With reference next to FIG. 4, an illustration of a registration database is depicted in accordance with an illustrative embodiment. In this figure, an example of an implementation for registration database 222 is shown. As depicted, registration database 222 includes unique identifiers 400 and profile identifiers 402.

Registration database 222 maps unique identifiers 400 to profile identifiers 402. For example, unique identifier 212 in FIG. 2 may be used as a key to find a record or a row in a table with profile identifier 404 in profile identifiers 402 for profile 144 in FIG. 1 for user 122 in FIG. 1. The data structures used depends on the structure and organization of registration database 222.

Profile identifiers 402 may take different forms. For example, profile identifiers 402 may be selected from at least one of a first name and a last name, a Social Security number, a record identifier, or some other suitable identifier that is used to locate profile 144 in FIG. 1 for user 122 in FIG. 1 in personalization database 126 in FIG. 1.

In the illustrative example, unique identifiers 400 are anonymized identifiers 406 such that the identities of users 102 in FIG. 1 may remain anonymous. As depicted, anonymized identifiers 406 cannot be used to identify the names of users 102.

In some illustrative examples, personalization database 126 in FIG. 1 is a human resources database that is configured to also be used as an advertising database. In other words, personalization database 126 is a dual use for human resource operations and advertising related operations. In other illustrative examples, personalization database 126 may be used in advertising-related operations and not human resource operations.

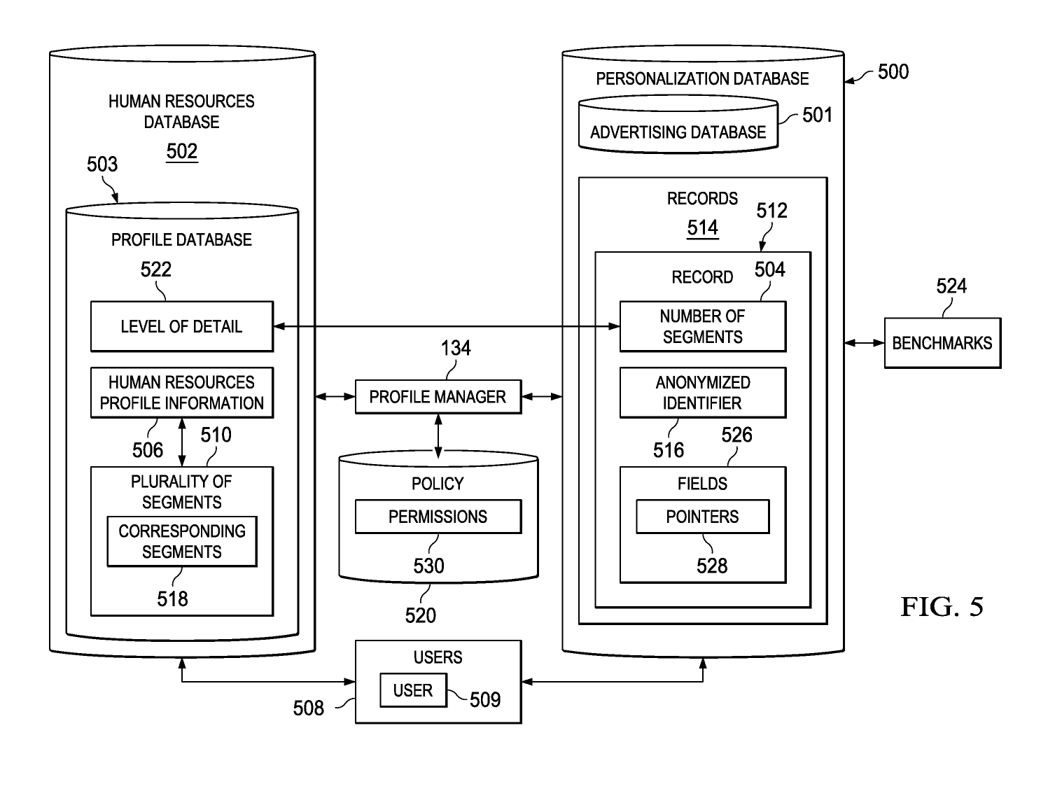

With reference now to FIG. 5, an illustration of a dataflow in creating a personalization database is depicted in accordance with an illustrative embodiment. In this illustrative example, personalization database 500 is an example of a form for personalization database 126 shown in FIG. 1. In this illustrative example, profile manager 134 handles requests for information about users using advertising database 501. As depicted, personalization database 500 is advertising database 501.

In this illustrative example, personalization database 500 is created using profile database 503, which may take the form of human resources database 502. In this illustrative example, profile manager 134 also includes functions for creating and managing personalization database 500 in addition to responding to requests for profile information for use in managing advertisements for users accessing web servers and other resources over a network, such as the Internet, an intranet, or some other type of network.

As depicted, profile manager 134 manages advertising database 501. Managing advertising database 501 includes at least one of creating, modifying, updating, or reading advertising database 501.

For example, profile manager 134 selects number of segments 504 of human resources profile information 506 about user 509 from plurality of segments 510 of human resources profile information 506 about user 509 located in human resources database 502. Plurality of segments 510 may be selected from at least one of a work location, a residence location, an age group, a gender, a title, an industry, a hobby, a type of insurance, a salary, of some other type or category of information.

As used herein, a “number of”, when used with reference to items, means one or more items. For example, “number of segments 504” is one or more segments.

In this example, selection of number of segments 504 may be made using policy 520. Profile manager 134 selects number of segments 504 of human resources profile information 506 about user 509 from plurality of segments 510 of human resources profile information 506 about user 509 located in human resources database 502 using policy 520. Further, level of detail 522 for number of segments 504 may be identified using policy 520.

For example, policy 520 may include permissions 530 from user 509. Profile manager 134 may select number of segments 504 of human resources profile information 506 about user 509 from plurality of segments 510 of human resources profile information 506 about user 509 located in human resources database 502 based on permissions 530 from user 509. As a result, different records in records 514 for different users in users 508 may have different segments from plurality of segments 510.

Profile manager 134 identifies record 512 for user 509 in records 514 in advertising database 501. In this example, profile manager 134 may identify record 512 for user 509 by creating record 512 in advertising database 501 or by finding an empty record in records 514 for use as record 512. Anonymized identifier 516 for user 509 is used to locate record 512 in advertising database 501.

In this example, anonymized identifier 516 is stored in record 512 for user 509 as an index to record 512. Anonymized identifier 516 is selected from one of a cookie, a device identifier, an Internet Protocol address, a device fingerprint, a browser fingerprint, or some other type of information that may be used to identify user 509.

Profile manager 134 places number of segments 504 selected from plurality of segments 510 in human resources database 502 into record 512 for user 509 in advertising database 501.

Further, profile manager 134 manages advertising database 501 by making updates to records 514 as needed. For example, profile manager 134 updates number of segments 504 of human resources profile information 506 about user 509 in record 512 in advertising database 501 when a group of corresponding segments 518 in plurality of segments 510 is updated in human resources database 502. In other words, when one or more of plurality of segments 510 change in human resources database 502, any of number of segments 504 that correspond to those segments are updated in record 512. For example, if an address is changed for user 509 in plurality of segments 510 in human resources database 502 and number of segments 504 includes the address, that segment in number of segments 504 is also updated in advertising database 501.

In another example, the updating also may include updating anonymized identifier 516 for user 509 when a new unique identifier is identified for user 509. For example, anonymized identifier 516 may be a device identifier. In this case, when user 509 has a new device, a new unique identifier is present for the new device. This new unique identifier may replace or supplement the current unique identifier, depending on whether user 509 has replaced the device or has obtained another device.

In some illustrative examples, benchmarks 524 may be associated with advertising database 501. Benchmarks 524 may be associated with advertising database 501 by being stored in advertising database 501 or by using pointers 528 stored to benchmarks 524 stored in advertising database 501.

Profile manager 134 identifies a group of benchmarks 524 for number of segments 504 of human resources profile information 506 about user 509 located in advertising database 501 and associates the group of benchmarks 524 with record 512 for user 509. This associating may be performed by profile manager 134 placing the group of benchmarks 524 in a group of fields 526 in record 512. In another example, profile manager 134 places a group of pointers 528 to the group of benchmarks 524 in the group of fields 526 in record 512.

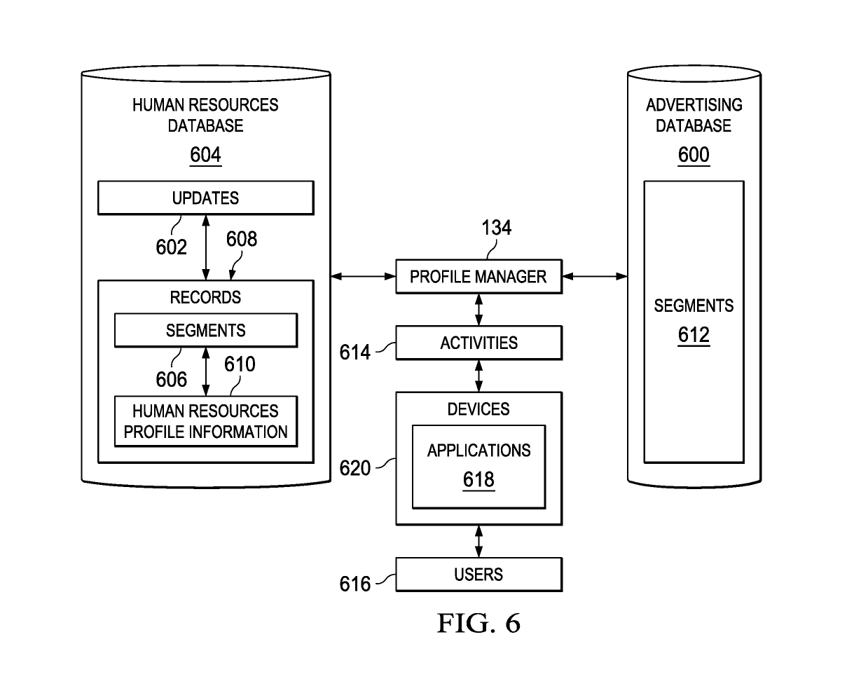

With reference next to FIG. 6, an illustration of dataflow in updating an advertising database is depicted in accordance with an illustrative embodiment. In this illustrative example, profile manager 134 manages advertising database 600. As depicted, advertising database 501 in FIG. 5 and personalization database 126 in FIG. 1 are examples of one manner in which advertising database 600 may be implemented.

As depicted, profile manager 134 updates advertising database 600. In other words, profile manager 134 makes changes to advertising database 600 to keep advertising database 600 as current as possible.

For example, profile manager 134 identifies updates 602 in human resources database 604 that are applicable to advertising database 600. In this example, updates 602 to segments 606 in records 608 for users are also in advertising database 600. Segments 606 are of human resources profile information 610 stored in records 608. Updates 602 are selected from at least one of an addition of information, a modification of information, a deletion of information, or other types of changes that may be made to information in segments 612.

Profile manager 134 may identify updates 602 in a number of different ways. For example, profile manager 134 may receive notifications from human resources database 604 that are relevant to segments 612 in advertising database 600 corresponding to segments 606 in human resources database 604. In other illustrative examples, profile manager 134 may query human resources database 604 to receive segments 606. In this type of implementation, profile manager 134 compares segments 606 to segments 612 to determine whether updates 602 have occurred that need to be made in segments 612.

Additionally, changes to segments 612 may be made by profile manager 134 when profile manager 134 detects activities 614 from users 616 utilizing applications 618 on devices 620. As depicted, applications 618 may be selected from at least one of a human resources application, a browser, a mobile application, or some other suitable application that operates on a device. In this illustrative example, devices 620 are selected from at least one of a computer, a laptop computer, a tablet, a mobile phone, or some other suitable type of device that may process information.

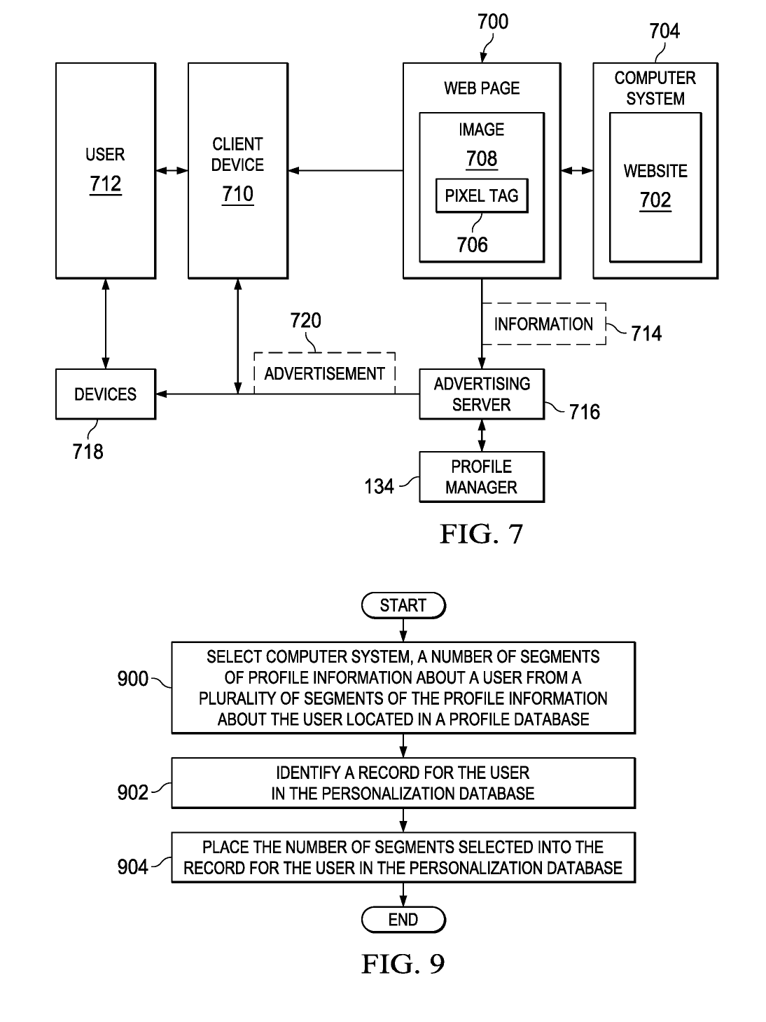

With reference now to FIG. 7, an illustration of dataflow in displaying advertisements on client devices is depicted in accordance with an illustrative embodiment. In this illustrative example, web page 700 is a web page for website 702. Website 702 is located on computer system 704.

In this illustrative example, web page 700 includes pixel tag 706 in image 708 in web page 700. Pixel tag 706 is a type of web beacon that is embedded in web page 700 in an unobtrusive manner. In other words, pixel tag 706 is usually not visible to a viewer of web page 700.

As depicted, web page 700 is displayed on client device 710 for user 712. In this illustrative example, pixel tag 706 includes code to send information 714 to advertising server 716. In this illustrative example, advertising server 716 may communicate with profile manager 134 to identify information about user 712.

For example, advertising server 716 may locate the group of devices 718 for user 712. The group of devices 718 for user 712 may be identified through profile manager 134. A part of segment information that profile manager 134 may access includes different devices that user 712 owns or uses. The identification of these devices may be based on unique identifiers for the devices themselves or on applications for user 712 that are on those devices. In this illustrative example, client device 710 may be a desktop computer, and the group of devices 718 may include at least one of a mobile phone, a tablet computer, a laptop computer, a workstation, or some other type of data processing system.

Advertising server 716 sends advertisement 720 to at least one of the group of devices 718 or client device 710 for user 712. The selection of advertisement 720 may be performed by communicating with profile manager 134 to obtain segment information about user 712 to select advertisement 720. In this manner, advertisement 720 may be sent to more than one device for user 712. Advertisement 720 may be sent to some or all of the devices used by user 712. Advertisement 720 may be sent when user 712 uses client device 710 or one more of devices 718. Advertisement 720 may be sent to browsers or other applications on these devices.

In this illustrative example, advertisement 720 may be sent to the group of devices 718 even though user 712 has not downloaded web page 700 on any of the group of devices 718. In this manner, an advertiser may show advertisement 720 on the group of devices 718 without user 712 accessing web page 700 from the group of devices 718.

The identification of user 712 is not needed to send advertisement 720 to the group of devices 718 in this illustrative example. Instead, the advertisement may be sent to the group of devices 718 when the group of devices 718 is identified as accessing web pages or other information on the Internet. This type of delivery of advertisements may be performed more efficiently to follow user 712 as user 712 uses different devices identified for user 712.

The illustrations of information environment 100 and the different components in FIGS. 1-7 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, although requestor 142 in FIG. 1 is shown as being part of sources 106 in FIG. 1, requestor 142 may be a separate component from sources 106. For example, requestor 142 may be a server or other hardware system that provides an interface between sources 106 and profile manager 134 in FIG. 1 in computer system 136 in FIG. 1. As another example, requestor 142 is shown as communicating directly with computer system 136. The exchange of request 138 in FIG. 1 and reply 150 in FIG. 1 may be routed through network 110 in FIG. 1.

Further, although advertising database 501 in FIG. 5 is shown as an example of personalization database 126 in FIG. 1, personalization database 126 may take other forms. For example, personalization database 126 may be human resources database 502 in FIG. 5. In this type of implementation, personalization database 126 has a dual use. Personalization database 126 may be used for both human resource operations and advertising operations. The same record for a user may be used both for human resources purposes and advertising purposes. When used for advertising purposes, the appropriate information in human resources profile information 128 in FIG. 1 is identified. This identification may be made using policy 216 in FIG. 2 as described above.

As another example, other types of user profile information 120 in FIG. 1 may be included in addition to human resources profile information 128 in personalization database 126 in FIG. 1. For example, user profile information 120 may include information obtained from tracking the activities of users 102 in FIG. 1. For example, websites visited, videos downloaded, items viewed, items purchased, and other activities of users 102 may be identified to include additional information in user profile information 120 in addition to human resources profile information 128.

For example, applications 112 in FIG. 1 may also gather information for use in human resources profile information 128 or other types of user profile information 120 as an extension to the other functions of applications 112. For example, applications 112 also may track activities of users 102 as they request or search for information 104 in FIG. 1. For example, applications 112 may track websites visited, web pages downloaded, items selected on web pages, and other activities of users 102 as an extension to the normal function of applications 112.

In yet another illustrative example, one or more human resources databases and advertising databases may be present in addition to human resources database 502 and advertising database 501 in FIG. 5. In still another illustrative example, advertising database 600 in FIG. 6 may also include benchmarks. Profile manager 134 in FIG. 1 may monitor sources of the benchmarks and make updates to the benchmarks in advertising database 600. Further, requestor 142 may take various forms such as an advertisement server, a website server, a social networking service server, or some other suitable type of hardware device or computer that may generate request 138.

As another example, personalization database 500 may take other forms other than advertising database 501. For example, personalization database 500 may be a content database that is used by a content server to personalize web pages for users. For example, personalization database 500 may be a content database for a service for an organization selected from one of an online social networking service, an online store, a government service, and other types of online entities that may personalize content for users. Further, the personalization may include more than one type of content. For example, when personalization database 500 is used by an online social networking service, personalization database 500 may be used to selected or generate content that is selected from at least one of advertisements, news stories, pictures, videos, or other types of content.

In some examples, pixel tag 706 in FIG. 7 does not need to be in image 708. Pixel tag 706 may be located in web page 700 to indicate that web page 700 has been sent to client device 710 for viewing. Also, other types of web beacons or tracking mechanisms may be used in addition to or in place of pixel tag 706. For example, the process may use cookies in addition or in place of pixel tag 706.

Turning next to FIG. 8, an illustration of a flowchart of a process for managing profile information is depicted in accordance with an illustrative embodiment. The process illustrated in FIG. 8 may be implemented in profile manager 134 in FIG. 1. The different steps may be embodied as program code for profile manager 134.

The process begins by receiving a request for a group of segments of profile information about a user from a requestor (step 800). The process then identifies a profile for the user in a profile database (step 802). The profile is comprised of the segments of the profile information about the user. In other words, each segment in the profile includes information about the user that has been categorized as belonging to a segment.

Next, the process sends a portion of the profile information corresponding to the group of segments in a reply to the requestor (step 804). In step 804, some or all of the profile information about the user is in the portion. In this manner, the requestor may generate an advertisement for inclusion in information sent to the user. For example, the requestor may place the advertisement in a web page or other content that is sent to an application running on a device for the user.

When the group of segments in the request is less than all of the profile information about the user, fewer resources are used to transmit the information over a network. For example, processor resources, bandwidth in the network, or other resources used in transmitting the information may be reduced. When a very large number of requests and replies is sent, bottlenecks, delays, and other undesired effects in the network may be reduced or avoided.

Turning to FIG. 9, an illustration of a flowchart of a process for managing a personalization database is depicted in accordance with an illustrative embodiment. The process illustrated in FIG. 9 may be implemented in profile manager 134 in FIG. 1. The different steps may be embodied as program code for profile manager 134 in FIG. 1.

The process begins by selecting computer system, a number of segments of profile information about a user from a plurality of segments of the profile information about the user located in a profile database (step 900);

The process identifies a record for the user in the personalization database (step 902). An anonymized identifier for the user is used to locate the record in step 902. The process places the number of segments selected into the record for the user in the personalization database (step 904) with the process terminating thereafter.

A profile manager for the personalization database handles requests for information about users. This profile information may be used to personalize content for users. Personalization may be a personalization of webpages or other content sent to an application running on a device operated by a user. In this manner, the profile database with the profile information about the user and other users enables personalization of content for the users.

The flowcharts illustrated in FIG. 8 and FIG. 9 may be applied to different types of profile databases. For example, the profile database may be human resources profile database or other suitable type of database that contains profile information. The flowcharts in FIGS. 8-14 illustrate steps performed using at least one of human resource profile information in a profile database and advertising database.

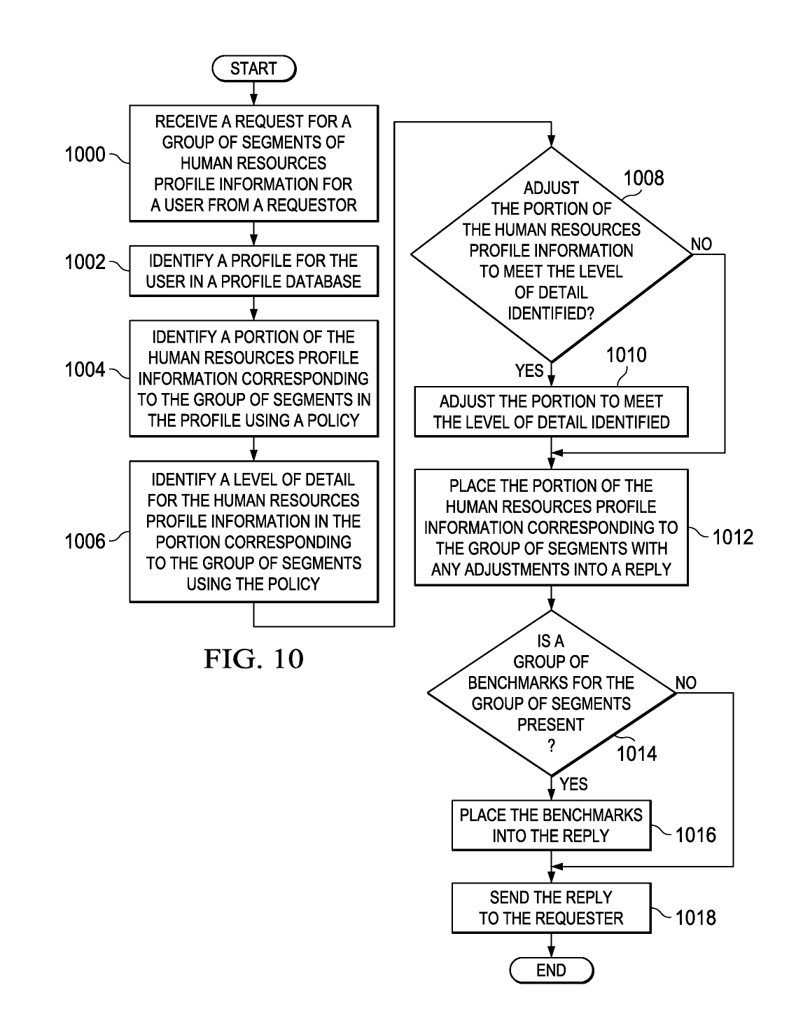

With reference now to FIG. 10, an illustration of a flowchart of a process for identifying human resources profile information using a policy is depicted in accordance with an illustrative embodiment. The process illustrated in FIG. 10 may be implemented in profile manager 134 in FIG. 1. The different steps may be embodied as program code for profile manager 134.

The process begins by receiving a request for a group of segments of human resources profile information about a user from a requestor (step 1000). The process identifies a profile for the user in a profile database (step 1002). The process then identifies a portion of the human resources profile information corresponding to the group of segments in the profile using a policy (step 1004).

Next, the process identifies a level of detail for the human resources profile information in the portion corresponding to the group of segments using the policy (step 1006). A determination is made as to whether to adjust the portion of the human resources profile information to meet the level of detail identified (step 1008). If the portion of the human resources profile information needs to be adjusted, the process adjusts the portion to meet the level of detail identified (step 1010). This adjustment may include at least one of generalizing information, removing information, creating ranges of values, or other suitable adjustments.

For example, if a salary is requested in a segment, the level of detail identified may be a salary range when the policy is applied. As a result, the portion of the human resources profile information identifying the salary may be changed to a range of salaries to perform the adjustment.

The process then places the portion of the human resources profile information corresponding to the group of segments with any adjustments into a reply (step 1012).

The process also determines whether a group benchmarks for the group of segments are present (step 1014). In step 1014, one or more of the segments may have one or more benchmarks. If a group of benchmarks is present, the process places the benchmarks into the reply (step 1016).

The process then sends the reply to the requestor (step 1018) with the process terminating thereafter. With reference again to step 1008, if the portion of the human resources profile information does not need to be adjusted, the process proceeds directly to step 1012 as described above. Turning back to step 1014, if a group of benchmarks is not present, the process proceeds to step 1018 as described above.

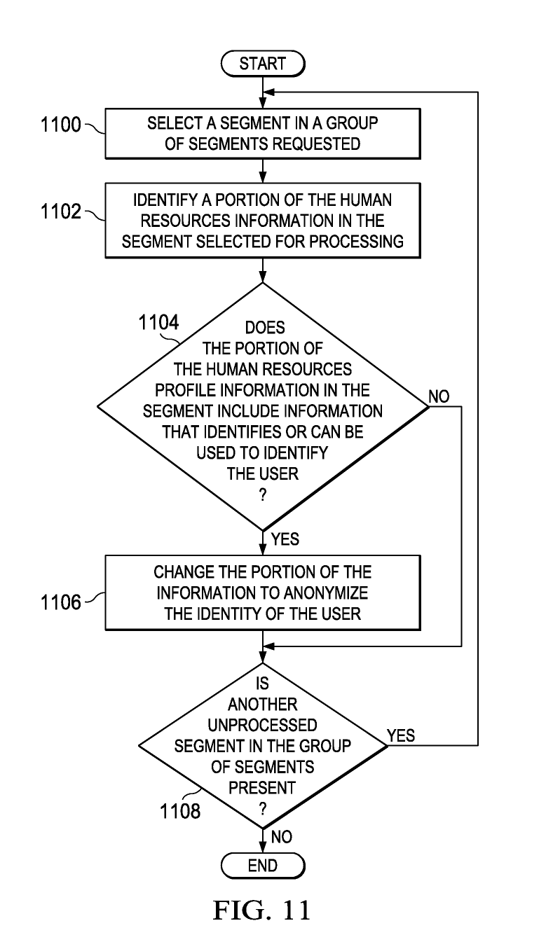

Turning now to FIG. 11, an illustration of a flowchart of a process for anonymizing human resources profile information is depicted in accordance with an illustrative embodiment. The process in FIG. 11 may be implemented in profile manager 134 in FIG. 1. The different steps may be embodied as program code that implements one or more rules in the policy that is applied by profile manager 134.

This process is implemented using a policy with rules that anonymize human resources profile information to avoid allowing other parties to ascertain an identity of a user from a portion of the anonymizing human resources profile information that is returned in the reply. In this example, the process is applied after the portion of the human resources profile information corresponding to a group of segments requested has been identified.

The process selects a segment in a group of segments requested (step 1100). Next, the process identifies a portion of the human resources profile information in the segment selected for processing (step 1102).

A determination is made as to whether the portion of the human resources profile information in the segment includes information that identifies or can be used to identify the user (step 1104). In step 1104, the process applies a policy that includes one or more rules for anonymizing information about the user. For example, the rule may state that names, addresses, social security numbers, or other information is not allowed to be sent.

If the portion of the human resources profile information in the segment includes information that identifies or can be used to identify the user, the process changes the portion of the information to anonymize the identity of the user (step 1106). Step 1106 may include removing the information, generalizing the information, or otherwise changing the information such that the user cannot be identified.

A determination is made as to whether another unprocessed segment in the group of segments is present (step 1108). If another unprocessed segment in the group of segments is present, the process returns to step 1100. Otherwise, the process terminates. With reference again to step 1104, if the portion of the human resources profile information in the segment does not include information that identifies or can be used to identify the user, the process also proceeds to step 1108.

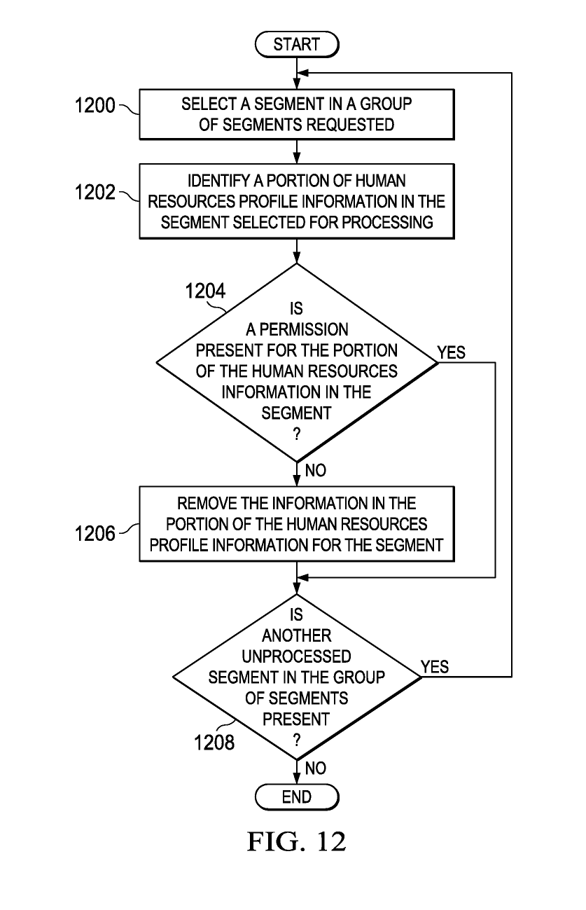

Turning to FIG. 12, an illustration of a flowchart of a process for processing permissions is depicted in accordance with an illustrative embodiment. The process illustrated in FIG. 12 may be implemented in profile manager 134 in FIG. 1 and is an example of one manner in which a policy may be used in identifying a portion of human resources profile information to return in a reply. The different steps may be embodied as program code that implements one or more rules in the policy that is applied by profile manager 134.

The process selects a segment in a group of segments requested (step 1200). Next, the process identifies a portion of human resources profile information in the segment selected for processing (step 1202).

A determination is made as to whether a permission is present for the portion of the human resources profile information in the segment (step 1204). In step 1204, the policy may include a rule as to whether the requestor has the permission for the segment.

For example, the permission may be based on whether the requestor has paid a fee or is willing to pay a fee for the information in the segment. The requestor may have the permissions to some of the segments and not others in the group of segments. As a result, the fee paid by the requestor may depend on how many of the segments are requested.

As another example, the policy may also include a rule as to whether the user has given the permission for the information in the segment to be returned in a reply. For example, the user may provide the permission for one or more of the segments in exchange for the fee.

If the permission is not present, the information in the portion of the human resources profile information for the segment is removed (step 1206). A determination is made as to whether another unprocessed segment in the group of segments is present (step 1208). If another unprocessed segment in the group of segments is present, the process returns to step 1200. Otherwise, the process terminates. With reference again to step 1204, if the permission is present, the process proceeds to step 1208.

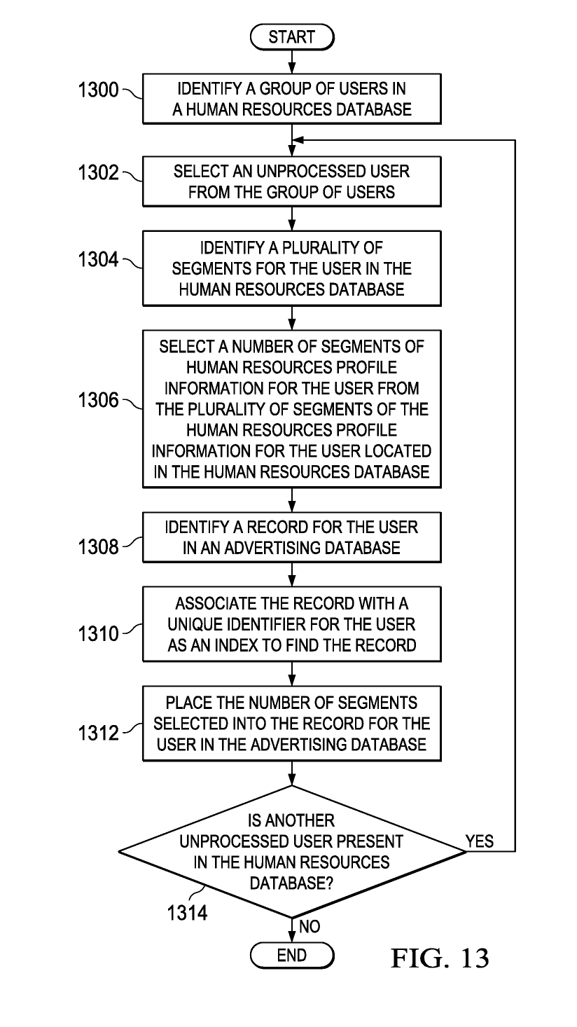

Turning next to FIG. 13, an illustration of a flowchart of a process for creating an advertising database with segmented profiles is depicted in accordance with an illustrative embodiment. The process illustrated in FIG. 13 may be implemented using profile manager 134 in FIG. 1 to create advertising database 501 in FIG. 5.

The process begins by identifying a group of users in a human resources database (step 1300). The group of users may be all or some of the users in the human resources database. The process then selects an unprocessed user from the group of users (step 1302). Next, the process identifies a plurality of segments for the user in the human resources database (step 1304). Each segment in the plurality of segments is located in one or more fields in a row of fields in a table in the human resources database in this example.

The process then selects a number of segments of human resources profile information about the user from the plurality of segments of the human resources profile information about the user located in the human resources database (step 1306). As illustrated, in some cases, the number of segments may be all of the plurality of segments, and, in other cases, the number of segments may only be a subset of the plurality of segments in the human resources database. The number of segments may be selected using a policy. In some cases, some users may have more segments than others depending on permissions that may have been obtained from the users.

The process identifies a record for the user in an advertising database (step 1308). In identifying the record, the record may be an empty row in a table in the advertising database. In another example, identifying the record may involve creating a new row in the table.

The process then associates the record with a unique identifier for the user as an index to find the record (step 1310). Afterwards, the process places the number of segments selected into the record for the user in the advertising database (step 1312).

A determination is made as to whether another unprocessed user is present in the human resources database (step 1314). If another unprocessed user is present, the process returns to step 1302. Otherwise, the process terminates. With this advertising database, a profile manager for the advertising database handles requests for information about users that may be received from requestors like advertising servers, web servers, or other types of devices or computer systems.

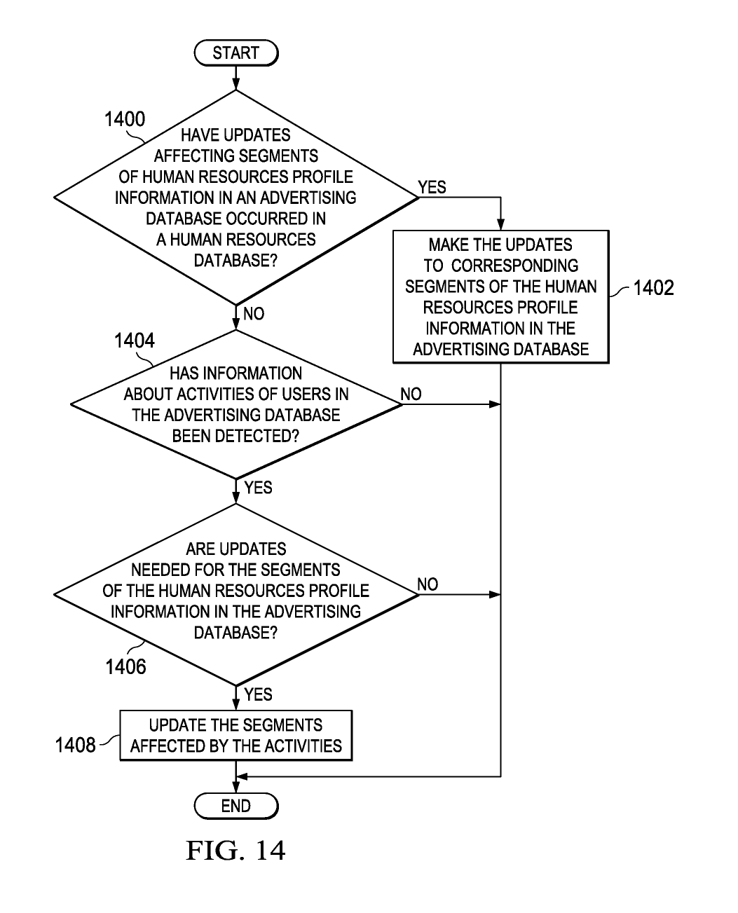

With reference now to FIG. 14, an illustration of a flowchart of a process for updating an advertising database is depicted in accordance with an illustrative embodiment. The process illustrated in FIG. 14 may be implemented in profile manager 134 in FIG. 1 to update an advertising database, such as advertising database 600 in FIG. 6.

The process begins by determining whether updates affecting segments of human resources profile information in an advertising database have occurred in a human resources database (step 1400). If the updates have occurred, the updates are made to corresponding segments of the human resources profile information in the advertising database (1402). The process terminates thereafter.

With reference again to step 1400, if updates have not been made to the human resources database, the process determines whether information about activities of users in the advertising database have been detected (step 1404). The activities of the users may be detected using any currently available techniques for tracking activities of users that access information on a network, such as the Internet. For example, these activities may be detected for users that visit websites and access information at websites. In other examples, the activities may be activities of the user operating an application on a device for the user.

If activities are detected, a determination is made as to whether updates are needed for the segments of the human resources profile information in the advertising database (step 1406). This determination may be made using a number of different techniques. For example, the activities may be analyzed to show if the activities affect the accuracy of the information and the segments. For example, the activities may indicate that the user has changed interests with respect to hobbies, clothing, or other items. If these items are ones tracked in the segments in the advertising database, updates may be made to those segments.

If updates are needed, the process updates the segments affected by the activities (step 1408) with process terminating thereafter. Otherwise, the process terminates without making updates. With reference again to step 1404, if information about activities of users in the advertising database have not been detected, the process also terminates. The process in FIG. 14 may be repeated any number of times to keep the advertising database current.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

For example, steps 1014 and 1016 in FIG. 10 are optional steps. Benchmarks are not necessary in all examples. As another example, step 1404, step 1406, and step 1408 in FIG. 14 may omitted in some examples.

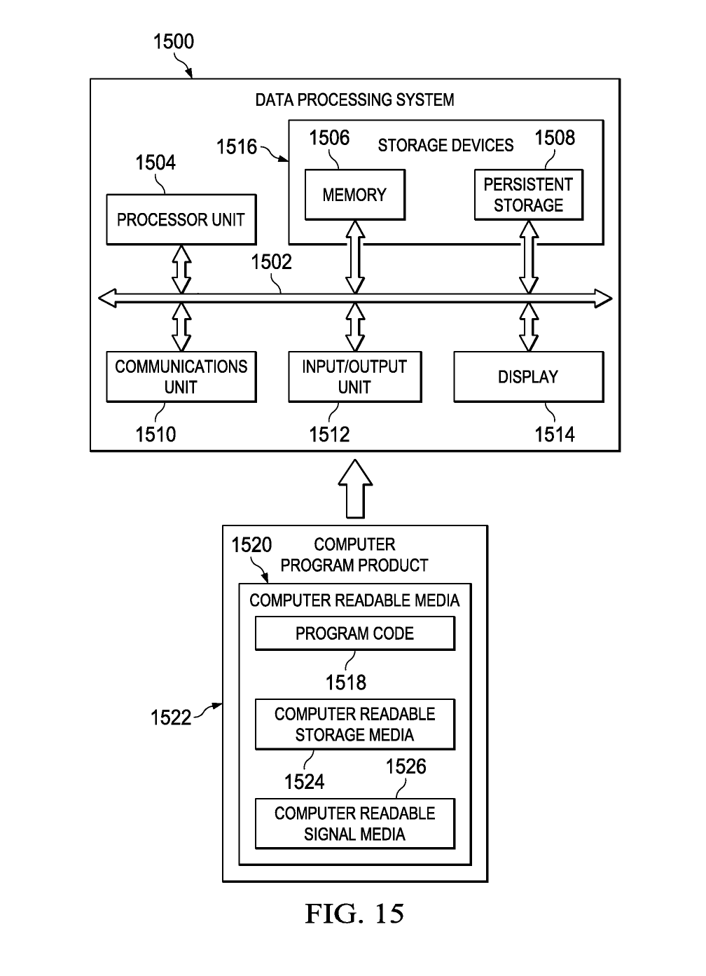

Turning now to FIG. 15, an illustration of a block diagram of a data processing system is depicted in accordance with an illustrative embodiment. Data processing system 1500 may be used to implement computer system 136, sources 106, and devices 108 in FIG. 1. In this illustrative example, data processing system 1500 includes communications framework 1502, which provides communications between processor unit 1504, memory 1506, persistent storage 1508, communications unit 1510, input/output unit 1512, and display 1514. In this example, communications framework 1502 may take the form of a bus system.

Processor unit 1504 serves to execute instructions for software that may be loaded into memory 1506. Processor unit 1504 may be a number of processors, a multi-processor core, or some other type of processor, depending on the particular implementation.

Memory 1506 and persistent storage 1508 are examples of storage devices 1516. A storage device is any piece of hardware that is capable of storing information, such as, for example, without limitation, at least one of data, program code in a functional form, or other suitable information either on a temporary basis, a permanent basis, or both on a temporary basis and a permanent basis. Storage devices 1516 may also be referred to as computer readable storage devices in these illustrative examples. Memory 1506, in these examples, may be, for example, a random access memory or any other suitable volatile or non-volatile storage device. Persistent storage 1508 may take various forms, depending on the particular implementation.

For example, persistent storage 1508 may contain one or more components or devices. For example, persistent storage 1508 may be a hard drive, a solid state hard drive, a flash memory, a rewritable optical disk, a rewritable magnetic tape, or some combination of the above. The media used by persistent storage 1508 also may be removable. For example, a removable hard drive may be used for persistent storage 1508.

Communications unit 1510, in these illustrative examples, provides for communications with other data processing systems or devices. In these illustrative examples, communications unit 1510 is a network interface card.

Input/output unit 1512 allows for input and output of data with other devices that may be connected to data processing system 1500. For example, input/output unit 1512 may provide a connection for user input through at least one of a keyboard, a mouse, or some other suitable input device. Further, input/output unit 1512 may send output to a printer. Display 1514 provides a mechanism to display information to a user.

Instructions for at least one of the operating system, applications, or programs may be located in storage devices 1516, which are in communication with processor unit 1504 through communications framework 1502. The processes of the different embodiments may be performed by processor unit 1504 using computer-implemented instructions, which may be located in a memory, such as memory 1506.

These instructions are referred to as program code, computer usable program code, or computer readable program code that may be read and executed by a processor in processor unit 1504. The program code in the different embodiments may be embodied on different physical or computer readable storage media, such as memory 1506 or persistent storage 1508.

Program code 1518 is located in a functional form on computer readable media 1520 that is selectively removable and may be loaded onto or transferred to data processing system 1500 for execution by processor unit 1504. Program code 1518 and computer readable media 1520 form computer program product 1522 in these illustrative examples. In one example, computer readable media 1520 may be computer readable storage media 1524 or computer readable signal media 1526.

In these illustrative examples, computer readable storage media 1524 is a physical or tangible storage device used to store program code 1518 rather than a medium that propagates or transmits program code 1518.

Alternatively, program code 1518 may be transferred to data processing system 1500 using computer readable signal media 1526. Computer readable signal media 1526 may be, for example, a propagated data signal containing program code 1518. For example, computer readable signal media 1526 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1500 are not meant to provide architectural limitations to the manner in which different embodiments may be implemented. The different illustrative embodiments may be implemented in a data processing system including components in addition to or in place of those illustrated for data processing system 1500. Other components shown in FIG. 15 can be varied from the illustrative examples shown. The different embodiments may be implemented using any hardware device or system capable of running program code 1518.

Thus, the different illustrative examples provide a method and apparatus for managing advertisements. In one illustrative example, human resources profile information is used to provide information for generating the advertisements. The human resources profile information identifies users. A profile manager anonymizes the human resources profile information as needed. The anonymization may be performed by applying a policy. The policy may generalize the information, omit the information, place the information into ranges, or in some other suitable manner to protect the privacy of the user.

Further, the list of examples also allows for the human resources profile information to be requested in segments. The use of the segments returns only the information that an advertiser is interested in for use in generating the advertisements.

As a result, less than all of the available human resources profile information about the user is returned to a requestor for use in generating an advertisement. In this manner, less information is sent, enabling a reduction in delays, bottlenecks, or other undesired effects that may occur when sending large amounts of the information over a network.

Further, a profile manager may allow more uses for the human resources profile information that is normally used only for human resource operations, such as those for payroll, health insurance, and benefits. With the profile manager, the human resources profile information may be used for other purposes, such as supplying information for advertising. As a result, a profile database with the human resources profile information may have a dual function. This dual function reduces time and effort needed to create a new database. Also, the amount of storage space in a computer system is reduced with this dual function.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. For example, although the illustrative examples have been described with respect to supplying human resources profile information for generating advertising, other illustrative examples may be applied to personalizing web pages generated by web servers. In this manner, the different steps illustrated may be used to provide web pages to users that are more personalized. Web pages may be modified or dynamically generated using the human resources profile information.

Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for managing a personalization database, the method comprising:
selecting, by a computer system, a number of segments of user profile information about a user from a plurality of segments of the user profile information about the user located in a profile database;
identifying, by the computer system, a record for the user in the personalization database, wherein an anonymized identifier for the user is used to locate the record; and
placing, by the computer system, the number of segments selected into the record for the user in the personalization database, wherein a profile manager for the personalization database handles requests for information about users, enabling personalization of content for the users.

2. The method of claim 1 further comprising:
updating, by the computer system, the number of segments of user profile information about the user in the personalization database when a group of corresponding segments is updated in the profile database.

3. The method of claim 1 further comprising:
storing, by the computer system, the anonymized identifier for the user as an index to the record.

4. The method of claim 1 further comprising:
updating, by the computer system, the anonymized identifier for the user when a new unique identifier is identified for the user.

5. The method of claim 3, wherein the anonymized identifier is selected from one of a cookie, a device identifier, a device fingerprint, and a browser fingerprint.

6. The method of claim 1, wherein selecting, by the computer system, the number of segments of the user profile information about the user from the plurality of segments of the user profile information about the user located in the profile database comprises:
selecting, by the computer system, the number of segments of the user profile information about the user from the plurality of segments of the user profile information about the user located in the profile database based on permissions from the user.

7. The method of claim 1, wherein selecting, by the computer system, the number of segments of the user profile information about the user from the plurality of segments of the user profile information about the user located in the profile database comprises:
selecting, by the computer system, the number of segments of the user profile information about the user from the plurality of segments of the user profile information about the user located in the profile database; and
identifying, by the computer system, a level of detail for the number of segments using a policy.

8. The method of claim 1 further comprising:
identifying, by the computer system, a group of benchmarks for the plurality of segments of the user profile information about the user located in the profile database; and
associating, by the computer system, the group of benchmarks with the record for the user.

9. The method of claim 8, wherein associating the group of benchmarks with the record for the user comprises:
placing the group of benchmarks in a group of fields in the record.

10. The method of claim 8, wherein associating, by the computer system, the group of benchmarks with the record for the user comprises:
placing, by the computer system, a group of pointers to the group of benchmarks in a group of fields in the record.

11. The method of claim 1 further comprising:
receiving the user profile information about the user from an application running on a device for the user.

12. The method of claim 1, wherein a segment in the plurality of segments is selected from one of a work location, a residence location, an age group, a gender, a title, an industry, a hobby, a type of insurance, and a salary.

13. An advertising system comprising:
A personalization database; and
a profile manager that selects a number of segments of human resources profile information about a user from a plurality of segments of user profile information about the user located in a profile database; identifies a record for the user in the personalization database, wherein an anonymized identifier for the user is used to locate the record; and places the number of segments selected into the record for the user in the personalization database, wherein the profile manager for the personalization database handles requests for information about users.

14. The advertising system of claim 13, wherein the profile manager updates the number of segments of the user profile information about the user in the personalization database when a group of corresponding segments is updated in the profile database.

15. The advertising system of claim 13, wherein the profile manager stores the anonymized identifier for the user as an index to the record.

16. The advertising system of claim 13, wherein the profile manager updates the anonymized identifier for the user when a new unique identifier is identified for the user.

17. The advertising system of claim 15, wherein the anonymized identifier is selected from one of a cookie, a device identifier, an Internet Protocol address, a device fingerprint, and a browser fingerprint.

18. The advertising system of claim 13, wherein in selecting the number of segments of the user profile information about the user from the plurality of segments of the user profile information about the user located in the profile database, the profile manager selects the number of segments of the user profile information about the user from the plurality of segments of the user profile information about the user located in the profile database based on permissions from the user.

19. The advertising system of claim 13, wherein in selecting the number of segments of the user profile information about the user from the plurality of segments of the user profile information about the user located in the profile database, the profile manager selects the number of segments of the user profile information about the user from the plurality of segments of the user profile information about the user located in the profile database and identifies a level of detail for the number of segments using a policy.

20. The advertising system of claim 13, wherein the profile manager identifies a group of benchmarks for the plurality of segments of the profile information about the user located in the personalization database and associates the group of benchmarks with the record for the user.

21. The advertising system of claim 20, wherein in associating the group of benchmarks with the record for the user, the profile manager places the group of benchmarks in a group of fields in the record.

22. The advertising system of claim 20, wherein in associating, by a computer system, the group of benchmarks with the record for the user, the profile manager places a group of pointers to the group of benchmarks in a group of fields in the record.

23. The advertising system of claim 13, wherein the profile manager receives the user profile information about the user from an application running on a device for the user.

24. The advertising system of claim 13, wherein a segment in the plurality of segments is selected from one of a work location, a residence location, an age group, a gender, a title, an industry, a hobby, a type of insurance, and a salary.

25. A computer program product for managing user profile information, the computer program product comprising:
a computer-readable storage media;
first program code, stored on the computer-readable storage media, for selecting a number of segments of the user profile information about a user from a plurality of segments of the profile information about the user located in a human resources database;
second program code, stored on the computer-readable storage media, for identifying a record for the user in a personalization database, wherein an anonymized identifier for the user is used to locate the record; and
third program code, stored on the computer-readable storage media, for placing the number of segments selected into the record for the user in the personalization database, wherein a profile manager for the personalization
